(19) United States
(12) Patent Application Publication
(10) Pub. No.: US 2020/0172415 A1
(43) Pub. Date: Jun. 4, 2020

(54) A HIGH THROUGHPUT FLUID TREATMENT SYSTEM

(71) Applicant: OPENWATER.IN PVT. LTD., Bangalore, Karnataka (IN)

(72) Inventors: Sanjiv SAMBANDAN, Bangalore, Karnataka (IN); Karthik RAGHUNANDAN, Bangalore, Karnataka (IN)

(21) Appl. No.: 16/616,417

(22) PCT Filed: May 24, 2018
(86) PCT No.: PCT/IN2018/050332

§ 371 Date: Nov. 22, 2019

(30) Foreign Application Priority Data
May 24, 2017 (IN) 201741018204

(51) Int. Cl. C02F 1/48; B03C 5/00; C02F 1/461; C02F 1/469; B03C 5/02; C02F 1/463

(52) U.S. Cl. CPC C02F 1/48; B03C 5/005; C02F 1/46109; C02F 2001/46171; B03C 5/02; C02F 1/463; C02F 2209/40; C02F 1/4696

(57) ABSTRACT

The invention provides a high throughput fluid treatment system. The high throughput fluid treatment system includes a pre-processing arrangement, at least two fluid filtration modules connected to the pre-processing arrangement and a post-processing arrangement coupled to the fluid filtration modules. A fluid filtration module is also provided. The fluid filtration module includes a plurality of concentric electrodes and a pair of insulating elements in cooperating arrangement with the concentric electrodes. The electrodes are configured to have a plurality of projections and/or indentations of various geometry. Further, the fluid filtration module includes a casing configured for placing the concentric electrodes and the insulating elements.

### FIELD OF INVENTION

The invention generally relates to the field of electromechanical devices and particularly to a high throughput treatment system.

### BACKGROUND

Water purification is a process of removing impurities and contaminants from water to make it potable. The impurities in the water include but are not limited to sand, mud, dissolved inorganic compounds, colloids, micro-organisms, pesticides and heavy metals. Various techniques for purification of water available in the art include but are not limited to membrane based filtration, adsorbent based, ion exchange, photo-catalytic, di-electrophoresis and irradiation.

Membrane based filtration techniques are further divided on the basis of the pore size of the membrane as micro-filtration, ultra-filtration, reverse osmosis and nano-filtration. Some significant disadvantages of these are high cost of membranes, low lifetime of membranes, high fabrication cost and high operation cost as high pressure is required for filtration. Adsorbent based techniques employ specially functionalized chemicals to remove the impurities. The usage of chemicals adds to pollutants and also at the same time expensive.

Ion exchange technique uses anion or cation exchange resins for purification of water. Ion exchange technique is generally used to remove hardness from water. Some of the disadvantages of ion-exchange are adsorption of organic matter, organic contamination from the resin itself and bacterial contamination.

Photo-catalytic reactions include decomposition of organic compounds into water and carbon dioxide. Dielectrophoresis depend on field gradient and therefore requires micro-fabrication. One significant disadvantage of photo-catalysis and dielectrophoresis is low efficiency due to generation of a weak electrical force. Hence, for effective purification combination of the aforementioned techniques is adopted. Combination of two techniques increases the cost of assembly and maintenance of the purification system. The known devices also have limitations in reducing biochemical oxygen demand (BOD) and chemical oxygen demand (COD) in fluids. Thus, there is a need to develop a filtration system that is economic, easy to fabricate, maintain and capable of filtering sub-micron sized particles.

### BRIEF DESCRIPTION OF DRAWINGS

So that the manner in which the recited features of the invention can be understood in detail, some of the embodiments are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a schematic representation of a high throughput fluid treatment system, according to an embodiment of the invention.

FIG. 2a shows a schematic representation of a fluid filtration module, according to an embodiment of the invention.

FIG. 2b shows an exploded view of the fluid filtration module, according to an embodiment of the invention.

FIG. 3a shows a schematic representation of the electrode arrangement, according to an embodiment of the invention.

FIG. 3b shows the exploded view of the electrode arrangement, according to an embodiment of the invention.

FIG. 3c shows a cross sectional view of the electrode arrangement, according to an embodiment of the invention.

FIG. 4(a)-(c) generally shows isometric electrodes having projections of various geometric patterns, according to an embodiment of the invention.

FIG. 5 shows an isometric view of an insulating element of the electrode arrangement, according to an embodiment of the invention.

### SUMMARY OF THE INVENTION

One aspect of the invention provides a high throughput fluid treatment system. The high throughput fluid treatment system includes a pre-processing arrangement, at least two fluid filtration modules connected to the pre-processing arrangement and a post-processing arrangement coupled to the fluid filtration modules.

Another aspect of the invention provides a fluid filtration module. The fluid filtration module includes a plurality of concentric electrodes and a pair of insulating elements in cooperating arrangement with the concentric electrodes. The electrodes are configured to have a plurality of projections and/or indentations of various geometry. Further, the fluid filtration module includes a casing configured for placing the concentric electrodes and the insulating elements.

### DETAILED DESCRIPTION OF THE INVENTION

Various embodiments of the invention provide a high throughput fluid treatment system. The high throughput fluid treatment system includes a first reservoir for storing a fluid. A pre-filtration chamber is connected to the first reservoir. A plurality of fluid filtration modules are connected to the pre-filtration chamber. A post-filtration arrangement is coupled to each of the fluid filtration module. A second reservoir is connected to the post-filtration arrangement, for storing filtered fluid. The device described herein briefly, shall be explained in detail.

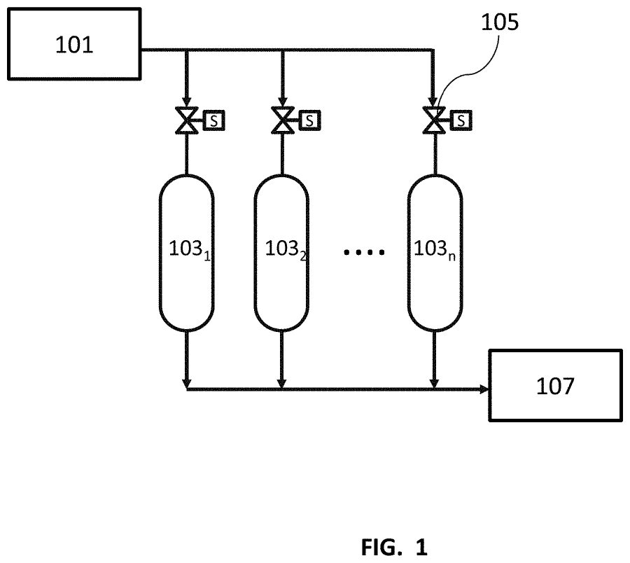

FIG. 1 shows a schematic representation of a high throughput fluid treatment system, according to an embodiment of the invention. The high throughput fluid treatment system includes a pre-processing arrangement 101. The pre-processing arrangement 101 includes a first reservoir and a pre-filtration chamber. The first reservoir is used to store a fluid. Example of fluid includes but is not limited to contaminated water. The fluid is then subjected to a time dependent electrical gradient. The time dependent electrical gradient is achieved through selective input of a specific frequency component of electric field. Further, the time dependent electrical gradient results in at least one of an enhanced diffusion limited aggregation (EDLA), a dipole-dipole interaction, a dielectrophoresis or an electro coagulation. The first reservoir is connected to the pre-filtration chamber. The pre-filtration chamber is configured to filter out the impurities. In one example of the invention, the impurities include suspended particles. Examples of pre-filtration chamber includes but is not limited to a sand filtration chamber, a candle filtration chambers, a plate and frame filter press chamber, an automatic filter press chamber, and a recessed plate filter press chamber. In one example of the invention, the pre-filtration chamber includes a metal mesh. The pre-filtration chamber is connected to at least two fluid filtration modules 103₁, 103₂, . . . , 103ₙ, hereinafter referred to as fluid filtration module 103. The system is provided with a means for regulating the flow of fluids to each fluid filtration module 103. In one example of the invention, the system is provided with a plurality of solenoid valves 105 for regulating the flow of fluid to each of the fluid filtration modules 103. In another example of the invention, the flow of fluids is regulated by using sensors. The fluid filtration modules 103 are arranged in series, parallel or a combination thereof. In one example of the invention, the fluid filtration modules 103 are connected in parallel. A post processing arrangement 107 is coupled to the fluid filtration modules 103. The post-processing arrangement 107 includes but not limited to at least one settling tank, at least one post filtration chamber and a second reservoir. The settling tank is configured for enabling settling of impurities that include micro particles. The settling tank is further connected to the post filtration chamber to filter out the remaining impurities to make the fluid potable. The second reservoir is coupled to the post filtration chamber for receiving the filtered fluid.

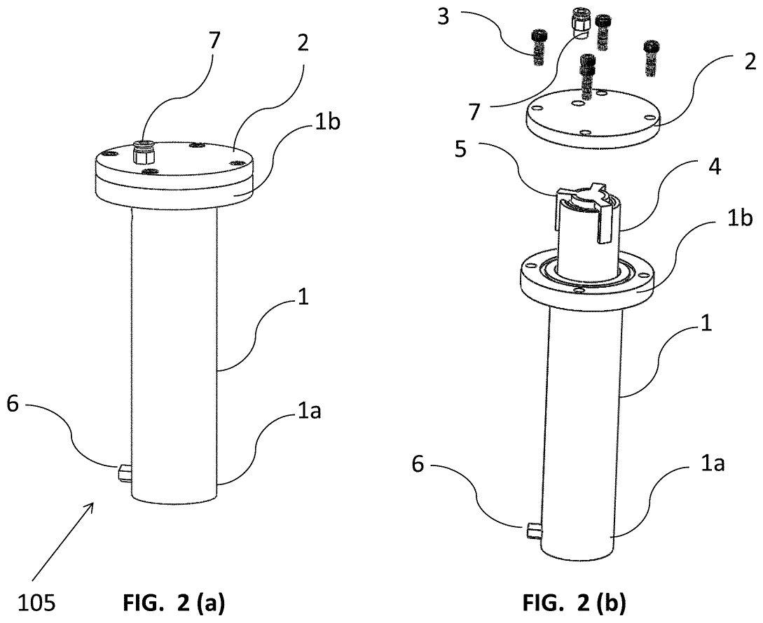

FIG. 2a shows a schematic representation of a fluid filtration module, according to an embodiment of the invention. The fluid filtration module includes a casing 1. The casing 1 includes an elongated hollow base 1a and a top surface 1b. The top surface 1b is provided with a lid 2. The casing 1 is provided with at least one fluid inlet 6 and at least one fluid outlet 7. The lid 2 is fixed to the top surface 1b by using a plurality of connecting means. In one example of the invention, the connecting means is a bolt 3.

FIG. 2b shows an exploded view of the fluid filtration module, according to an embodiment of the invention. The fluid filtration module includes a plurality of concentric electrodes 4a, 4b, 4c. The concentric electrodes 4a, 4b, 4c are separated by a pair of insulating elements 5. The pair of insulating elements 5 is in cooperating arrangement with the concentric electrodes 4a, 4b, 4c. The concentric electrodes 4a, 4b, 4c and the insulating elements 5 are placed in the casing 1. In one embodiment of the invention, the casing 1 is configured to act as an electrode.

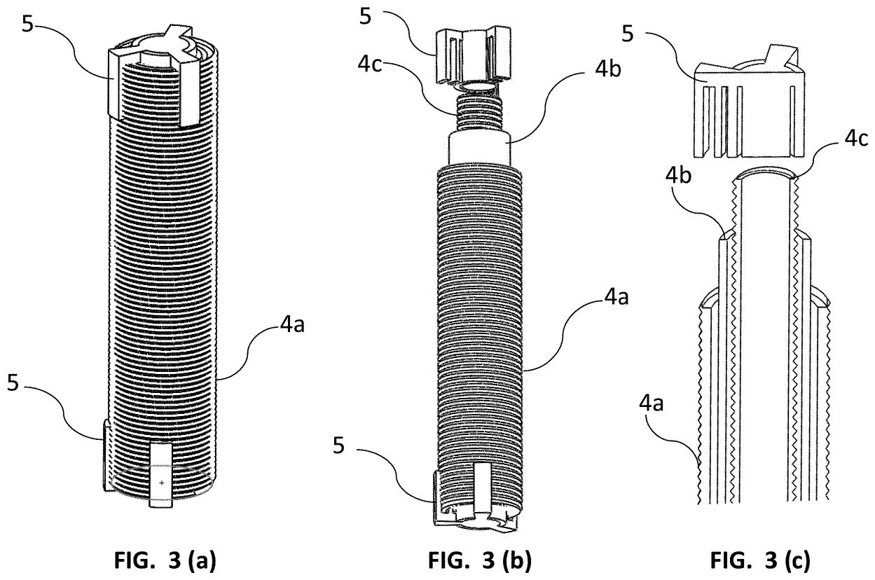

FIG. 3a shows a schematic representation of the electrode arrangement, according to an embodiment of the invention. The electrode arrangement shows the plurality of concentric electrodes 4a, 4b, 4c and the pair of insulating elements 5 in cooperating arrangement with the concentric electrodes. Each of the electrodes is a positive electrode and/or a negative electrode. In one example of the invention, the concentric electrodes 4a, 4b, 4c include alternatively arranged positive and negative electrodes.

FIG. 3b shows an exploded view of the electrode arrangement, according to an embodiment of the invention. In one embodiment of the invention, the electrodes are configured to have projections and/or indentations of various geometric patterns. The projections and/or indentations described herein can be on interior surface and/or exterior surface of the concentric electrode. The projections and/or indentations on the electrodes enhance the dielectrophoresis effect, improve the penetration depth of the electric field in the fluid and increase the surface area for electro coagulation. In one example of the invention, the alternate electrodes are configured to have projections and/or indentations on the exterior surface of the electrode. Examples of geometric patterns include but are not limited to a speckled pattern, a threaded pattern, a nerved pattern and a wire wound pattern. FIG. 3c shows a cross sectional view of the electrode arrangement, according to an embodiment of the invention.

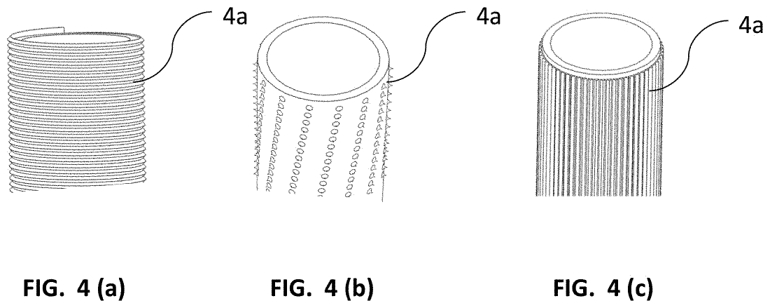

FIG. 4(a)-4(c) generally shows electrodes having projections of various geometric patterns, according to an embodiment of the invention. FIG. 4(a) shows a threaded electrode, according to an embodiment of the invention. FIG. 4(b) shows a speckled electrode, according to an embodiment of the invention. FIG. 4(c) shows a nerved electrode, according to an embodiment of the invention.

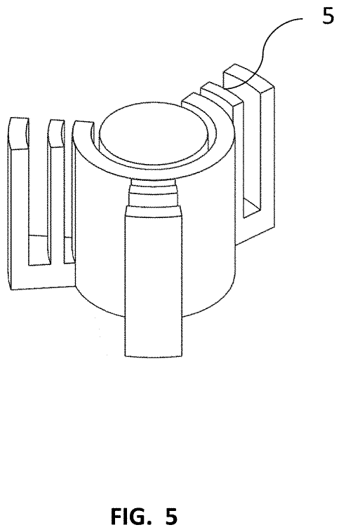

FIG. 5 shows an isometric view of an insulating element of the electrode arrangement, according to an embodiment of the invention. The pair of insulating elements 5 is configured for providing spacing between the concentric electrodes 4a, 4b, 4c.

### INDUSTRIAL APPLICABILITY

The fluid is fed into the concentric electrodes through the inlet of the fluid filtration module. The alternate electrodes are configured to have projections of various geometric patterns to improve the efficiency of filtration. When the fluid passes through the concentric electrodes, the fluid is subjected to a time dependent electrical gradient to obtain filtered fluid. The time dependent electrical gradient is achieved through selective input of a specific frequency component of electric field. Further, the time dependent electrical gradient results in at least one of an enhanced diffusion limited aggregation (EDLA), a dipole-dipole interaction, a dielectrophoresis or an electro coagulation. Thus, the invention provides a high throughput fluid treatment system which is cost effective, energy efficient and easy to maintain. The applications of high throughput fluid filtration system includes but are not limited to industrial waste water treatment, domestic and sewage waste water treatment, river water purification and groundwater water purification. The fluid filtration removes the impurities that include but are not limited to Arsenic, Nitrates Fluoride and bacteria. The high throughput filtration system purifies the sewage waste water and makes it potable. The foregoing description of the invention has been set for merely to illustrate the invention and is not intended to be limiting. Since modifications of the disclosed embodiments incorporating the spirit and substance of the invention may occur to a person skilled in the art, the invention should be construed to include everything within the scope of the appended claims and equivalents thereof.

1-17. (canceled)

18. A fluid treatment module, comprising:
an electrode arrangement including at least a positive electrode and a negative electrode that are concentric;
a plurality of projections and indentations are disposed on the at least positive electrode and are configured an enhanced diffusion limited aggregation (EDLA), a dipole-dipole interaction and a dielectrophoresis and an electro-coagulation;
a pair of insulating elements are disposed between the at least positive and negative electrodes to provide fluid spaces for permitting the flow of a fluid and where the fluid is configured to undergo a time dependent electric gradient; and
the electrode arrangement is disposed in an electrode casing.

19. The fluid treatment module as claimed in claim 18, wherein the patterns of the plurality of projections and indentations are threaded, speckled and nerved or a combination thereof.

20. The fluid treatment module as claimed in claim 18, wherein a fluid inlet and a fluid outlet are connected to the electrode casing.

21. The fluid treatment module as claimed in claim 18, wherein the fluid treatment module is portable.

22. The system as claimed in claim 18, wherein a selective input of a specific frequency component of an electric field is configured for the time dependent electrical gradient.

23. A high throughput filtration system, comprising:
a pre-processing arrangement;
at least a pair of fluid treatment modules including an electrode arrangement including at least a positive electrode and a negative electrode that are concentric;
a plurality of projections and indentations are disposed on the at least positive electrode and are configured an enhanced diffusion limited aggregation (EDLA), a dipole-dipole interaction and a dielectrophoresis and an electro-coagulation;
a pair of insulating elements are disposed between the at least positive and negative electrodes to provide fluid spaces for permitting the flow of a fluid and where the fluid is configured to undergo a time dependent electric gradient;
the electrode arrangement is disposed in an electrode casing; and
a post-processing arrangement coupled to the at least pair of the electrode arrangement.

24. The system as claimed in claim 23, wherein the patterns of the plurality of projections and indentations are threaded, speckled and nerved or a combination thereof.

25. The system as claimed in claim 23, wherein a fluid inlet and a fluid outlet are connected to the electrode casing.

26. The system as claimed in claim 23, wherein the system is portable.

27. The system as claimed in claim 23, wherein means for regulating the flow of fluids are connected to the fluid treatment modules and are selected from a solenoid valve and sensors.

28. The system as claimed in claim 23, wherein the fluid treatment modules are arranged in series, parallel or in a combination thereof.

29. The system as claimed in claim 23, wherein a selective input of a specific frequency component of an electric field is configured for the time dependent electrical gradient.
